(19) United States
(12) Patent Application Publication
(10) Pub. No.: US 2004/0073790 A1
(43) Pub. Date: Apr. 15, 2004

(54) Intermediated delivery scheme for asymmetric fair exchange of electronic items

(76) Inventors: Giuseppe Ateniese, Timonium, MD (US); Breno F. De Medeiros, Cockeysville, MD (US); Michael T. Goodrich, Irvine, CA (US)

Correspondence Address: Whitman Curtis & Christofferson, Suite 305, 11491 Sunset Hills Road, Reston, VA, 20190, US

(21) Appl. No.: 10/332,614

(22) PCT Filed: Jul. 13, 2001
(86) PCT No.: PCT/US01/22074

(51) Int. Cl. H04L 9/00; H04K 1/00; G06F 17/60

(52) U.S. Cl. 713/165; 713/176; 380/281; 705/62

(57) ABSTRACT

A methodology and system is used to facilitate the exchange of valued electronic information in a confidential, fair, and efficient manner. Either of two protocols can be employed that used encryption and electronic signatures to effectively guarantee origin and identity of sender and receiver in the exchange of valued information and requires timely response by both sender and receiver. The protocols rely upon one or a plurality of postal agents (servers) to provide secured online exchange of the information by arranging an efficient validation of the required signatures and information being exchanged between the sender and receiver. In the event of a breakdown in the exchange between sender and receiver, the use of a trusted third party (TTP) allows for fair and pre-agreed arbitration based upon the encrypted information and electronic signatures of the sender and receiver. The method does not require the use of the TTP unless a dispute arises.

### DESCRIPTION

### BACKGROUND OF THE INVENTION

1. Field of the Invention

The invention is generally directed to a methodology and system which facilitates the exchange of electronic information in a confidential and fair manner.

2. Description of the Prior Art

In today's economy, there is a need to exchange data that has high intrinsic value in a manner which is confidential and which assures fairness in exchange between the parties. The type of data involved in these exchanges is wide ranging, and can include commercial, medical education and scientific data, software code, and the like. This data has high intrinsic value, and can facilitate faster development of medical, scientific and commercial innovations. Thus, facilitating such exchanges can have great economic and technological impact.

In the non-electronic world, a receipt is issued simultaneously with purchase of a product. Conversely, in the digital or electronic world, simultaneity is not generally feasible. This is because the protocols which have been devised to permit simultaneous exchange of electronic information or “electronic items” between two computers demand high level of computational power and/or communication bandwidth. This lack of simultaneity in electronic transactions creates a “fairness” issue. If the purchaser issues a receipt before obtaining the product (e.g., the electronic information or items), he may be denied the product from the supplier while nevertheless being charged for it. Similarly, the purchaser may refuse to pay for a product he has received before issuing a receipt, and later claim that there is no proof he has ever purchased the electronic item.

Fair exchange is a classical problem in cryptographic research. By “fair” we mean that neither of the parties should have a significant chance of securing the desired object of the exchange while simultaneously frustrating the other party. For instance, a protocol which would allow the sender to obtain a receipt without disclosing the electronic information to the receiver would not be “fair”. At a high level we can broadly classify the existing protocols for fair exchange of information as cryptological, optimistic or online. Though strictly speaking, online protocols are not fair exchange protocols, they are of practical relevance, especially in the case of the asymmetric type of exchange. Furthermore one can speak of the fairness of an online protocol in similar terms as with optimistic protocols, by formal derivations from a set of trust assumptions.

Cryptological fair exchange protocols use successive rounds of communication in which the two items are progressively transmitted. This cannot be applied directly to the case where the second item is a receipt which includes a description of the first item. In that case, the receipt cannot be fully generated until the first item is entirely known. For that case, the cryptological protocols function in a way that at each round, the probability that each party will be able to determine the exact contents of the message from the information received up to that round progressively increases towards 1 (100%).

A common setback of all cryptological protocols is their high communication costs. A classical reference for cryptological protocols involving progressive exchange can be found in the book of Bruce Schneier, Applied Cryptography: Protocols, Algorithms and Source Code in C. The article of S. Even, O. Goldreich and A. Lempel, “A randomized protocol, for signing contracts”, Comm. ACM 28, 6 (1987) describe a probabilistic cryptological protocol. The fairness in this protocol depends strongly on the assumption that both parties have similar computational powers, or else there would be a point in the transaction in which one of the parties could complete the missing bits by exhausting the remaining possibilities while the other party could not afford the computational cost of doing the same. The paper by M. Ben-Or, O. Goldreich, S. Micali and R. Rivest, “A fair protocol for signing contracts”, IEEE Transactions in Information Theory IT-36(1), (1990), is a protocol that does not need to assume similar computational powers for both parties. However, it still does not eliminate the high costs of this kind of protocols.

Online protocols are those that employ a trusted third party which act as a delivery channel. Both parties send their items to the trusted party. This trusted party can then check for their integrity, ensuring the validity and fairness of the exchange, and forward the items to the intended receivers. Such protocols have been implemented and commercialized by companies providing various certified or secure services on the Internet. See, for instance, http://www.certifiedemail.com. This company accepts e-mails for delivery and provides the sender with a receipt. The contents of the exchange are either revealed to the company or else may be encrypted, but in that case the receipt does not validate the message, only an encryption using an unknown key which is not validated by the receipt.

Franklin and Reiter, in “Fair exchange with a semi-trusted third party”, Proc. ACM Conf. on Computer and Communications Security, 1997, introduced the notion of a semi-trusted third party for the fair exchange problem. Their protocol is online as it requires a trusted third party (TTP) to be involved in any transaction. The TTP can sometimes fail or misbehave, but it cannot conspire with either of the parties involved in the exchange. However, their model is somewhat restrictive since it assumes that at most one party misbehaves. If the sender cheats, for instance, then the recipient and the TTP must both be honest. This implies that if the TTP misbehaves, then the other two parties must be honest, and in principle, they could simply exchange their items without a TTP.

An online scheme for certified e-mail is presented in J. Zhou and D. Gollman, “Certified Electronic Mail”, Computer Security-ESORICS'96 Proceedings (1996). The protocols in that paper employ a series of trusted servers. The multiplicity of servers is needed to guarantee broad geographical area coverage, thus easing the bottleneck of a single server. However, under these protocols the malfunctioning of a single server would compromise the whole scheme.

An elegant online solution using six messages is presented in the paper by A. Bahreman and J. D. Tyger, “Certified Electronic Mail”, Proceedings of the Symposium on Network and Distributed Systems (1994). This paper describes a monotonic system providing non-repudiation. However, the paper does not discuss the issue of confidentiality from the trusted party. Another online protocol is discussed in the paper by R H. Deng, L. Gong, A. A. Lazar and W. Wang, “Practical Protocols for Certified E-mail”, Journal of Network and Systems Management, 4(3), 1996. However, the Gong et al. protocol also does not discuss the issue of confidentiality from the trusted party. Furthermore, the online protocols discussed above place high demands on the trusted party, and requires the use of servers that are both highly available and highly secure, and the result is a structure which does not scale well.

A fair exchange is an optimistic scheme if the parties cooperate directly in the exchange without the direct intervention of a trusted party. In case both parties act honestly the protocol terminates with both parties satisfied with the outcome. If however one of the parties cheat, the other party has enough evidence to secure him/herself a satisfactory outcome by requesting the help of a trusted third party. Thus it is a category of adjudicated protocols (protocols in which a trusted entity adjudicates disputes but is not needed when the parties are honest) and is called optimistic because one of the parties must be the first to disclose the desired information to the other.

J. Riordan and B. Schneier present two protocols for certified e-mail (the basic certified asymmetric exchange) in “A Certified E-Mail Protocol”, 13^{th} Annual Computer Security Applications Conference, (1998), one of which is online and the other optimistic. In the online version, the sender (conventionally named) Alice sends the receiver Bob an encrypted message. Bob publishes a dated request for the key in the trusted publishing location, which in practice could be implemented as a secure database server. If Alice submits the key for publishing within the time period appointed by Bob, that will constitute Alice's evidence of delivery, i.e., her receipt. In the optimistic version, Alice sends the key directly to Bob, who then responds with a receipt for the key. If Bob does not reply within reasonable time, then the protocol reverts to the online version. This scheme achieves timeliness, confidentiality and non-repudiation, but does not address the bottleneck problem in the online protocol, which is further compounded by the third party being needed also to verify valid outcomes. In the optimistic version the outcome format depends on whether or not the exchange resulted in a dispute. Verification of validity in the case of disputes demands active participation of the trusted third party, thus, the third party is not invisible.

N. Asokan, V. Shoup and M. Waidner have addressed the problem of optimistic protocols for fair exchange in “Optimistic Fair Exchange of Digital Signatures”, Tech. Rep. RZ, 2973, IBM Research (1997) and “Asynchronous Protocols for Optimistic Fair Exchange”, Proceedings of the IEEE Symposium on Research in Security and Privacy (1998). In these papers they describe meta-protocols that can be instantiated to any case of optimistic fair exchange. While optimal within this general context, we believe that their setup is too complex for the asymmetric case of exchange of an item for a receipt. Symmetric fair exchanges, which must support the case of mutually signing of a contract, involves more subtle difficulties than the asymmetric case. Furthermore, the asymmetric case is important enough to deserve consideration on its own. For instance, the instantiation of their general protocol to the asymmetric case of certified e-mail involves at least five messages. Finally, their system cannot guarantee both timeliness and monotonicity.

U.S. Pat. No. 5,666,420A (Sep. 9, 1997) of Silvio Micali, which is herein incorporated by reference, describes a three message protocol for optimistic, asymmetric fair exchange. We note that this is an optimal scheme, as far as the number of messages is concerned. It does not, however, guarantee timeliness of termination for the receiver. The initiator Alice encrypts a message with the receiver's (Bob's) public key. She then further encrypts that with the trusted party's (TTP's) public key and sends it to Bob. Bob, receiving what he knows is an encrypted message from Alice, issues a receipt and sends it to Alice. Upon verifying the receipt, Alice sends to Bob the message, now encrypted only with Bob's public key, Bob decrypts the message and reads it.

In the case that Alice does not respond with the message in the third message, Bob can take the first message and his signature to the TTP. The TTP will then decrypt the message and give it to Bob, while forwarding the message to Alice. Since the message was first encrypted with Bob's public key, the confidentiality of the transaction is guaranteed even in the special case. While simple and elegant, the above protocol has a disadvantage. It places too large a burden on Bob. After Bob has issued and released the receipt, he does not know what kind of time interval to wait for a reply from Alice before complaining to the trusted third party. If the communication with Alice is asynchronous, for example, via e-mail, then a waiting interval of several days may be reasonable. Bob must decide what he will consider an acceptable wait time, and then resort to help. During that time, he has exonerated Alice of any responsibility by giving her his receipt, though he cannot utilize the information sent by Alice. This is a serious inconvenience of the protocol which might discourage user acceptance of the protocol.

It thus seems that with optimistic protocols scalability is obtained at a cost. In particular, optimistic exchanges achieve timeliness of exchange only at the expense of monotonicity or of homogeneity of outcome. For instance, in the case of certified e-mail the receiver of the e-mail can be guaranteed timeliness for his/her part in the transaction only if he/she is allowed to request that his/her signature on a receipt be revoked by the trusted party. In a more general fair exchange, one of the parties first discloses the item in his/her possession. If it does not immediately receive the item it desires in return, he/she will have to decide how long to wait before it concludes that the other party is cheating or broken and resort to the trusted third party.

U.S. Pat. No. 6,137,884 (Oct. 24, 2000) of Silvio Micali describes two schemes that utilize a third party (therein called a post office) to effectuate the simultaneous exchange of information and receipt. In the first method, called a sending-receipt method, Alice sends to the post office an encrypted message that only Bob can read. The post office then signs and forwards the message to Bob while simultaneously sending to Alice a properly signed receipt indicating that the message has been forwarded to Bob. The use of electronic signatures allows Alice to identify the receipt she gets from the post office with the message she sent to Bob. A drawback to this method, however, is that Alice can obtain a receipt without Bob ever having received the message if, for example, a disruption in the communication between the post office and Bob occurs. To address this problem, Micali teaches a second scheme in which the post office sends the signed receipt back to Alice and forwards onto Bob an encrypted version of the message. In this scheme Bob cannot read the message until he acknowledges receipt and thereby obtains from the post office the information necessary to decrypt the message. The post office may or may not return this second receipt to Alice. In the mean time, Alice has already received a signed receipt acknowledging that her message was sent onto Bob. Thus, a drawback to this approach is that Alice can obtain a valid receipt without Bob having received a useable (i.e., decodable) message. In this approach, Bob cannot turn to an independent party to obtain the decoded message, and thus is left vulnerable if the post office misbehaves.

### SUMMARY OF THE INVENTION

It is an object of this invention to provide a method and system for fair exchange of electronic information which is efficient, highly confidential and which ensures undeniable proof of delivery.

It is another object of this invention to provide a method and system for fair exchange of electronic information that makes it very hard and expensive to cheat or misbehave, thus increasing the confidence level of parties wishing to exchange valuable data stored in electronic format on computer databases.

It is yet another object of this invention to provide a method and system for efficient certified e-mail protocols for electronic information transfer that make use of a trusted third party (TTP) which acts as a delivery channel and which acts in an optimistic way, i.e., the TTP is involved only in case of dispute (which preferably is a rare event).

It is still another object of this invention to provide a method and system for certified e-mail protocols for electronic information transfer that uses distributed TTP's which can have different levels of trust.

Our protocol is an online protocol which adopts a different structure from existing ones. It distributes responsibilities so that one server must be highly secure, but not necessarily highly available. The communication demands on it are lower than in traditional online schemes. Several servers are preferably employed for the delivery of messages. Preferably, these can be easily duplicated so they do not need to be highly secure. This will increase the availability of the system at a lower cost. The secure server we refer to as the trusted third party (TTP), while the other servers are called agents.

The protocol we describe solves the prior problems of certified e-mail schemes for electronic information exchange by introducing an asymmetry in the exchange. From the point of view of the party initiating the exchange it is an online protocol with the agent a trusted delivery channel. From the point of view of the second party it is an optimistic protocol performed with an online agent contracted by the other party.

In the context of this invention, by online protocol we mean any protocol in which a first party communicates electronically with other parties through the intermediation of a party trusted to all parties. The first party of an online protocol has no legal resort or protection against misbehavior of the intermediating party. An example of an online protocol is the one described in patent U.S. Pat. No. 6,137,884 of S. Micali, which is herein incorporated by reference.

In this invention the sender's view of the protocol is logically that of an online protocol, though the sender's trust on the postal agent may be reduced by using a multiplicity of postal agents and a simple secret sharing scheme of “xor” shares, as described in the invention.

In the context of this invention, by optimistic protocol we mean any protocol in which two parties, not mutually trusting each other, engage in an electronic exchange and at least one of the parties has a legal resort to a trusted third party for arbitration in the case the other party misbehaves. The outcome of each application of an optimistic protocol is guaranteed to be fair to both parties, whether or not that application involved arbitration by the trusted party. Example of an optimistic protocol is such as in papers of Asokan et al., “Optimistic protocols for multi-party fair exchange”, IBM Research Report RZ 2892 (Dec. 9, 1996) and Asokan et al., “Optimistic fair exchange of digital signatures”, IBM research report.

In the context of this invention the recipient's view of the protocol is that of an optimistic exchange with a live party. This is an important difference between optimistic protocols such as described in patent U.S. Pat. No. 5,666,420 of S. Micali, which is herein incorporated by reference. Micali assumes asynchronous communication and cannot give strong timeliness guarantees and ours, which gives de facto timeliness guarantees to the recipient of the message.

This asymmetric model of communication results from an asymmetrical, but realistic, trust model. Alice, as initiator of the exchange, chooses the agent to intermediate the exchange, not unlike contracting a real agent in the physical world. Thus it is not unreasonable to expect that she should trust the agent. On the other hand Bob does not need to trust the agent. However, Bob can expect the agent to be available. Any delays on the agent's part (which is a dedicated server) can be reasonably construed by Bob as a strong indication of dishonesty or malfunctioning of the agent. If the full cycle of exchange includes asynchronous exchange—as in the case of certified e-mail—a delay of days on the part of the initiator of the exchange does not necessarily constitute an indication of dishonesty on her part, while a delay of a few minutes on the part of the agent server, which is always online, may constitute enough reason for an appeal to the trusted party. This gives de facto timeliness guarantees to both parties, which in turn should result in a smaller number of disputes, as long as the agents remain available and functional the number of complaints should be minimal. Such a scheme will look much more attractive to users: In fact, it achieves the simultaneity of exchange that makes online protocols attractive, while preserving the confidentiality of the transaction and assuming less of the delivery agent in terms of trust. The management of the delivery agents is also easier, since a malfunctioning or corrupted agent can be quickly taken out of the system without so much disruption as might be the case in more traditional online schemes.

### BRIEF DESCRIPTION OF THE DRAWINGS

The foregoing and other objects, aspects and advantages will be better understood from the following detailed description of the preferred embodiments of the invention with reference to the drawings.

FIG. 1 is a schematic diagram showing the sequence of messages in the optimistic exchange;

FIG. 2 is a schematic diagram illustrating a first protocol according to the present invention;

FIG. 3 is a schematic diagram illustrating a second protocol according to the present invention;

FIG. 4 is a flow diagram showing the sequencing of the first protocol according to the present invention; and

FIG. 5 is a flow diagram showing the sequencing of the second protocol according to the present invention.

### DETAILED DESCRIPTION OF THE PREFERRED EMBODIMENTS OF THE INVENTION

The invention is directed to a method and system for the fair exchange of electronic information. The invention has particular application to a certified e-mail service which uses cryptographic tools to provide proof that a particular message was delivered between two parties at a certain time. However, it should be understood that invention can be adapted for use in a variety of methods and systems where it is necessary to assure that two parties in an electronic transaction are provided with a fair and confidential means of exchange. The invention is designed to achieve the following.

Fairness: No party should be able to interrupt or corrupt the protocol to force an outcome to his/her advantage. In any instance of the protocol, it should terminate with either party having obtained the desired information, or with neither one acquiring anything useful.

Monotonicity: Each exchange of information during the protocol should add validity to the final outcome. That is, the protocol should not require any messages, certificates, or signatures to be revoked to guarantee a proper termination of the protocol. This is important, because if revocation is needed to ensure fairness, then the verification of the validity of the protocol outcome becomes a bottleneck as it requires the active participation of a TTP.

TTP invisibility: A TTP is visible if the end result of an exchange makes it obvious that the TTP participated during the protocol.

Non-repudiation of receipt: The recipient of the message should not be able to deny having received the message if indeed the message was delivered.

Non-repudiation of origin: The sender should not be able to deny having sent the message.

Realistic trust models: The trust model should be based on realistic assumptions the users are comfortable with. A system that places less trust in outside parties is more likely to be accepted.

Efficiency: The protocol should not involve excessive computational and communication costs. It should lend itself to reasonably fast implementations.

Timeliness: Roughly speaking, timeliness guarantees that both parties will achieve obtaining their desired items in the exchange within a finite time or that at least one party has the ability to decide to abort the normal operation of the protocol and adopt a scheme for protocol resolution that can be executed in a finite, preferably short, period of time.

Confidentiality: In case the exchange is deemed confidential, the protocol should not need to disclose the message contents to any other party except for sender and recipient. In particular, other trusted or semi-trusted parties acting as intermediaries should not be able to read the contents of the confidential e-mail.

Most of the protocols of fair exchange of electronic items in the prior art do not provide any level of confidentiality. They allow a TTP (which is needed as an arbitrator to ensure fairness) to see the contents of the exchange, at least in the exceptional cases in which there is a dispute and active arbitration by the third party is needed. This invention, by contrast, allows the arbitration to be performed without violating the confidentiality of the exchange. In particular, the e-mail messages are certified without revealing their contents to third parties. This should promote the commercial development of certified e-mail services since the third party will be trusted to perform transmission, storage and dispute resolution, but will not need to be trusted to keep the information involved private.

The invention is a hybrid protocol which combines the strengths and overcomes the disadvantages of both optimistic and online approaches.

The invention is applicable for scale up. The invention introduces the notion of postal agents (PAs) which are distributed servers act on behalf of the TTP, with each PA requiring minimal trust in itself The PAs are online but they do not resolve disputes, which are still handled by the TTP. The protocol is monotonic, in that each party cannot revoke a message after it has been sent (like physical certified mail) and make use of conventional, publicly available cryptographic technology, such as digital signatures and public-key cryptography. Additionally, the protocol provides TTP's invisibility, and achieves confidentiality from both the TTP and the PAs which are able to verify the validity of a proof-of-receipt and proof-of-origin without knowing the e-mail content.

In the invention, the PAS are semi-trusted, in the sense that they can fail or misbehave, and, in addition they can conspire with either of the parties involved in the exchange. The TTP is trusted in that it cannot fail or misbehave or conspire with any of the parties.

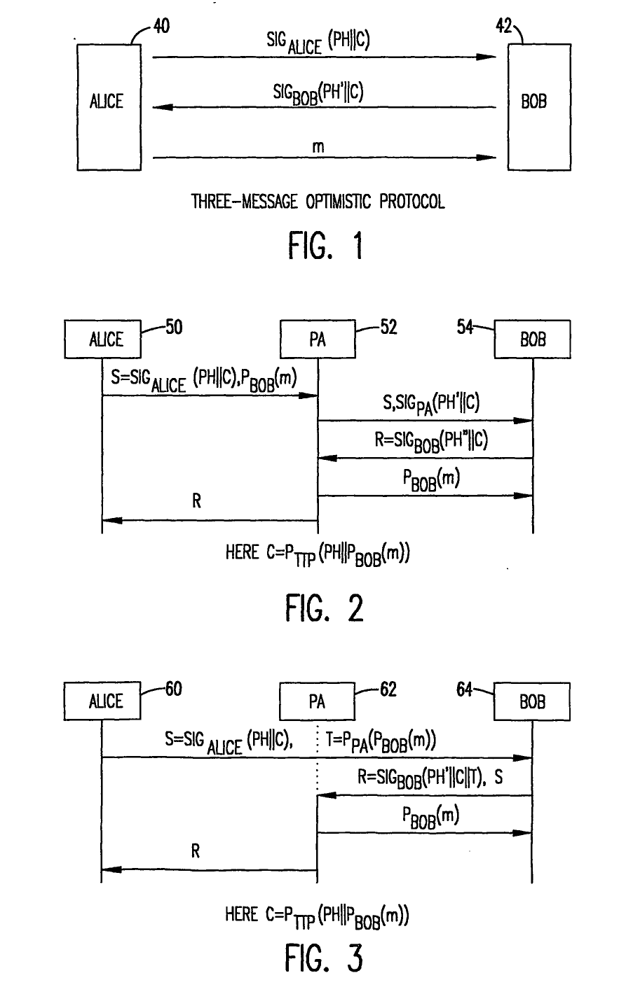

FIG. 1 shows a simple optimistic protocol that will be used as a sub-protocol in the inventive method and system. In the optimistic approach, the protocol terminates successfully without intervention of the trusted party if sender and recipient both act honestly. Only in case of dispute, the TTP is involved. The general ideas is as follows: The initiator, Alice 40, first encrypts a message m with the public-key of the recipient, Bob 42. The result P_{Bob}(m) is further encrypted under TTP's public-key, achieving

Z=P_{TTP}(P_{Bob}(m)) Equation 1.

This doubly encrypted message is sent to Bob. Bob then issues a receipt by sensing Alice his signature on Z. Upon verifying the receipt, Alice then sends Bob the message m. If Alice does not reply, Bob sends Z and his signature on it to the TTP which will then recover P_{Bob}(m) and give it to Bob, while forwarding Bob's receipt to Alice. Since the message was first encrypted with Bob's public-key, the confidentiality of the transaction is guaranteed even in this special case.

This three step protocol provides simplicity, but it needs to be modified slightly in order to achieve timely termination. In particular, a time limit should be incorporated into the protocol, otherwise Bob might never reply or might decide to resolve the protocol with the TTP after a certain amount of time that may be unacceptable to Alice.

Based on the premise that Alice wishes to send a message m to Bob, and wants a signed receipt back, Alice produces an identification token for herself containing her name and e-mail address for responses and other identified information (such as a public-key certificate). This is identified as Id_{A}. The generation of this token involves no secrets and can be done by any entity from publicly available information about Alice. In fact, Alice also generates (or retrieves) a similar token for Bob (Id_{B}) and for the TTP (Id_{TTP}).

The identification tokens will be combined with other parameters, such as a timestamp, a nonce n_{A} (a random number), and a time limit in a protocol header (PH). A PH within the context of this invention will be any information attached to a message that provides attributes about or concerning the message, but is not inherently a part of the message. In this protocol, both timestamps and nonces are needed to prevent replay attacks. The header also should contain other pertinent information about the protocol, such as the encryption, authentication, and signature algorithms used. Equation 2 sets forth the relationship of these variables.

PH={Id_{A}∥Id_{B}∥Id_{TTP}∥protocol descriptors} Equation 2

where ∥ denotes the concatenation operation. Alice then encrypts m with Bob's public-key and concatenates the result with PH, which is subsequently encrypted under TTP's public key. Equation 3 sets forth the resulting cipher text:

C=P_{TTP}(PH∥P_{BOb}(m)) Equation 3

Alice concatenates the above with the protocol header, signs it and sends the resulting signature to Bob. Equation 4 sets forth this operation as is depicted in FIG. 1.

Sig_{Alice}(PH∥C) Equation 4

Sig_{Alice}(*) implies that the signed plaintext is also available, either because the signature scheme allows for message recovery or because the plaintext is attached to the signature.

Bob receives the messages, and, from PH, he gets relevant information to properly generate a receipt. A receipt within the context of this invention is any return message which inherently authenticates that a given message has reached its intended destination. Bob can discard the message or he may decide to read the content, which implies a receipt must be sent to Alice. The receipt is a signature of Bob, as set forth in Equation 5.

Sig_{Bob}(PH′∥C) Equation 5

The signature of Bob is shown in FIG. 1, and serves the function of stating that he has indeed received a message from encrypted as specified in PH. A signature within the context of this invention is any confidential electronic notation that inherently and uniquely identifies the signer. The new protocol header PH′ contains a new timestamp and the specifications of the signature algorithm. It also includes the old PH and indicates that the signed message is indeed a receipt. Upon receiving Bob's receipt, Alice releases the message m.

The only place where the protocol can be interrupted with an unfair outcome is after the transmission of the second message, when Alice has Bob's signature but Bob cannot yet read the message. If Alice does not send Bob the third message, Bob contacts the TTP, forwarding the contents of the messages in the first two steps. The TTP decrypts C, checks the protocol headers, and then verifies Bob's receipt. If all is correct, it gives Bob the message P_{BOb}(m) and forwards the receipt to Alice (in case Bob didn't send the second message before complaining).

Under the scheme of FIG. 1, Bob is signing encrypted information which constitutes a statement to the fact that he received the message. This is made explicit in the receipt by the concatenation of the protocol header PH′ with the encrypted message. Since Bob can take steps to ensure recovery of the message contents, he cannot repudiate his signed receipt on the sole basis that the message received was encrypted and unintelligible. The verification of the receipt can be done by encrypting twice the message m in order to compute C and then checking Bob's signature via public verification algorithms specified in PH′. Alice must also provide the signed message of the first step of the protocol.

In the preferred implementation of this invention, the message in the third step is concatenated with another protocol header in order to allow the recipient to properly link this protocol step with the two previous ones. If confidentiality is not required, the encryption with Bob's public key could be avoided without compromising the other guarantees of the protocol.

In the present invention, a hybrid scheme is used which achieves the benefits of the optimistic and online protocols. The inventive system contemplates a highly-secure and fully-trusted server (TTP) and several low-cost semi-trusted servers which are referred to as Agents (Postal Agents PAs). In a fair exchange scheme, the Agents are directly involved in the exchange but they can misbehave or simply crash, in which case the TTP is invoked in order to handle this exceptional case. A PA within the context of this invention is any computer, server or other device which is aware of the necessary sequence of exchange of information between a sender and the receiver and is used to facilitate the fairness of the exchange. The inventive protocol distributes responsibilities so that the TTP need not be highly available, thus lowering the communication demand on it. The Agents are semi-trusted servers acting as intermediaries between the two parties involved in the exchange. This increases the availability of the entire system at a lower cost. Furthermore, the inventive system and method addresses the situation where the Agents conspire with either of the main parties. The Agent server is initially chosen by the message originator. Because of this, it is assumed that the PA will not conspire with the recipient of the message.

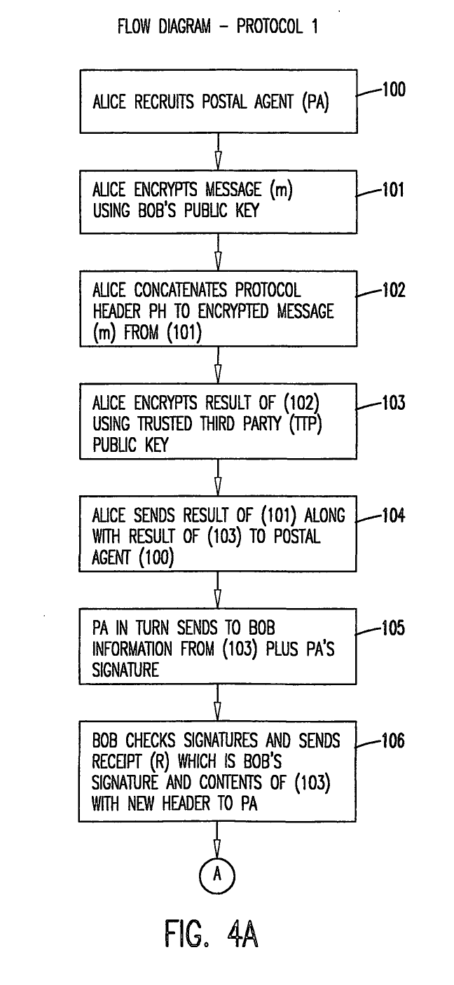

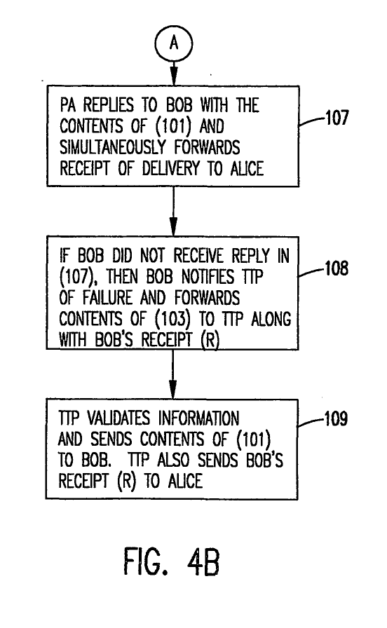

FIG. 2 illustrates one embodiment of the processes of this invention and is also shown in the flow diagram of FIG. 4. First, Alice 50 recruits the PA 52 to intermediate the interchange on her behalf (100). She gives PA 52 the message m encrypted with Bob's public key (P_{BOb}(m)). Then the protocol proceeds with an optimistic exchange between PA 52 and Bob 54. At the end, PA 52 forwards Bob's receipt to Alice 50. In operation, the communication is performed through private and authenticated channels. There are two protocol versions for accomplishing the above. The first version requires five messages to be completed, and the second version requires only four.

Protocol 1. The five message version is shown in FIG. 2 and is also shown in the flow diagram of FIG. 4 and works as follows: Alice encrypts the message m first with Bob's public-key (101), and concatenates the protocol header PH to the ciphertext (102). She then encrypts the result under TTP's public-key and signs it (103). The signature is sent to PA along with _{PBob}(m) (104). Optionally, Alice could ask PA to provide her with a proof-of-mailing (a receipt from PA) in reply to her first message. Next, PA and Bob perform an optimistic exchange. Specifically, PA sends Bob the request from Alice along with its own commitment to the transaction in the form of a signature. Bob checks the signatures and sends the receipt to PA (106) which replies with the encrypted message P_{Bob}(m) while forwarding the receipt to Alice (107).

PA can fail or conspire with Alice. Bob can complain with the TTP if he does not receive the last message from PA, in which case, he forwards the TTP the content of the first message received from the PA and his receipt (108). As in the optimistic protocol, the TTP performs the necessary checks, sends P_{BOb}(m) to Bob and, finally, forward's Bob's receipt to Alice (109). The signature of Alice, S, constitutes the proof-of-origin. Moreover, each protocol header, such as PH, must include the identities of all parties involved. In particular, it must include the identities of Alice, PA and Bob, as well as the TTP's identity in case of multiple TTPs. In addition, PH must be included in the encryption under TTP's public-key. All this is done to prevent subtle replay attacks. For instance, Bob could claim that the encrypted message m had been sent to him by a colluding partner. The TTP would then decrypt the message for Bob and forward Bob's receipt to the cheater, who would conveniently (for Bob) dispose of it. As before, a time limit should be included in the protocol headers, which implies that Bob cannot recover the message after that specified time. Since a proof-of-origin is useless without the corresponding message body. Alice's liability immediately ends after the time limit if Bob has not recovered the message, and provided Alice with the receipt.

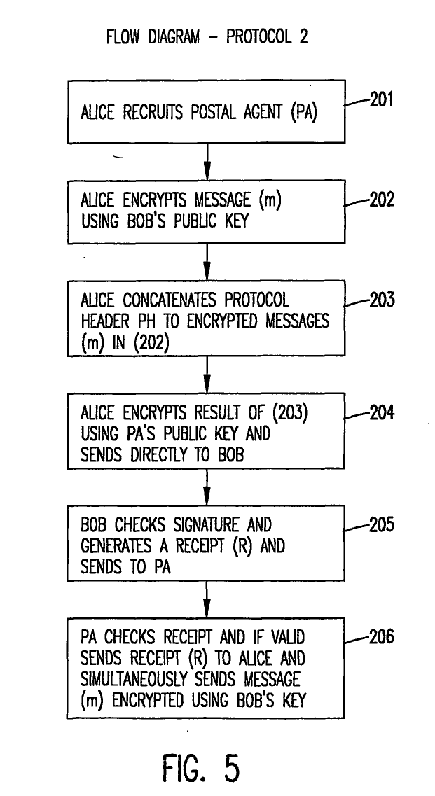

Protocol 2: The second version of this invention is shown in FIG. 3 and the flow diagram of FIG. 5, and is very similar to Protocol 1, but it only requires four messages, which is optimal for online protocols. As before, the system and method addresses the situation where the PA can misbehave, fail, or conspire with the message originator. This is achieved as follows: Alice 60 recruits a postal agent PA 62 to act as intermediary (201). She sends the signature S in Protocol 1 directly to Bob along with P_{Bob}(m) but encrypted under PA's public-key (202) (203) (204). Bob checks the signature and generates a receipt. Bob cannot read the message m since it has been encrypted for the postal agent. Alice's message is then forwarded to PA 62 by Bob 64, along with the receipt (205). If the receipt is valid, it is sent to Alice 60 by PA 62, which also forwards P_{BOb}(m) to Bob 64 (206). In case of a dispute, Bob contacts the TTP as discussed above.

In Protocol 2, Bob should sign both C and T in his message. By contrast, in Protocol 1, Bob only needs to complain to the TTP if the PA is not forthcoming. This is an unlikely event. In particular, in Protocol 1, if the PA is honest, it is not possible for Alice to cheat, as the contents of here message can be verified for consistency by the PA. However, in Protocol 2, Alice sends Bob the contents directly, and Bob cannot verify that C and T are linked in any way. Thus, if Bob signed only C he would have to rely on the TTP to solve further disputes, as he does not trust the PA to discard his signature after Alice's dishonesty has been verified. The entire role of the PA would thus be a redundant one. On the other hand, by signing both C and T, Bob safeguards himself against dishonesty on Alice's part. The verification algorithm is modified to compute both C and T from the private message P_{BOb}(m) and to check their consistency as well as Bob's signature on them; and thus Bob will have to resort to the TTP only if the PA misbehaves, as is the case in Protocol 1.

Although Protocol 2 is more efficient, there are advantages to Protocol 1. First, it may be preferred that Bob should have a signature from PA before issuing the receipt. This signature constitutes a commitment of the PA to the transaction and helps Bob collecting evidence that can be useful in case of dispute. Second, PA may not be willing to act on Alice's behalf at some point. For instance, PA may charge Alice for its service, but Alice may refuse to pay. If this is the case, then Alice and PA should first negotiate payment terms and then involve Bob in the exchange. In Protocol 2, PA may decide not to terminate the protocol, after Bob generated and forwarded the receipt because of issues with Alice, thus requiring bob to complain with the TTP.

The trust models discussed above assumes that Alice, the sender, trusts PA which cannot conspire with Bob by providing him the message without collecting the receipt. This is a plausible assumption since Alice initiates the transaction, freely choosing PA. Within a business model, a contract can be set in which agent agrees to provide its services to Alice. Bob, on the other hand, while trusting the TTP (as do all parties), does not need to place trust in PA chosen by Alice.

An extension of this scheme is possible in order to eliminate Alice's need to trust the postal agent. Alice can select several agents and send each the signature S along with a distinct share of the ciphertext P B_{bob}(m). Each postal agent would then transfer S and its own commitments to Bob in exchange for the receipt. If the receipt is valid, each agent would send its own share to bob. Bob can retrieve the ciphertext P_{Bob}(m) by pooling together all the shares. This is done via simple secret sharing schemes. If Bob does not receive all the shares or the message is not the one expected, he can complain with the TTP. Bob would still be protected against any of the agents cheating, while Alice would have the guarantee that Bob could not retrieve anything useful unless all the agents she hired conspire with Bob.

The shares can be made by xoring the ciphertext with random numbers with the same bitlength. For three agents, Alice would generate two random numbers r₁ and r₂. Then, she would send to the first agent the message defined by Equation 6.

S=Sig_{Alice}(PH∥C), r₀=_{Pbob}(m) ⊕r₁⊕r₂ Equation 6

The second agent would receive S and r₁ and the third one, S and r₂. If the receipt is valid, bob receive the shares r₀, r₁, r₂, and then computes the ciphertext according to Equation 7.

P_{Bob}(m)=r₀⊕r₁⊕r₂ Equation 7

It is enough that at least one postal agent is honest in order to protect Alice from colluding attacks.

During the receipt verification process, Alice provides the message m which is then encrypted by the verifier twice to achieve the value set forth in Equation 8.

C=P_{TTP}(PH∥P_{Bob}(m)) Equation 8

Once C is computed, the verifier checks the signatures of Bob that constitutes the proof-of-receipt. This verification is also performed by Bob when he received P_{Bob}(m) from PA in order to check that the message he is reading is the same contained in the receipt R. If the message is different, then Bob contacts the TTP to solve the dispute. This implies that the public encryption algorithms P_{B}(*), P_{TTP}(*) should be deterministic. If they are randomized, then Alice must also provide the random parameters used during the encryption phase.

In the inventive system and method, a practical technique is preferably adopted. Specifically a Message Authentication Code (MAC) can be used to construct a heuristically secure encryption scheme. A practical construction for a MAC function is described in Bellare et al., Keying hash functions for message authentication, pages 1-15, called HMAC. Then one would encrypt m according to Equation 9.

Eₖ(m∥HMAC₁(m)) Equation 9

where Eₖ is a symmetric encryption algorithm, such as DES in CBC mode, and k and l are random session keys. The keys k and l can be encrypted using public-key cryptography, as set forth in Equation 10.

P_{bob}(k∥l) Equation 10

where P_{Bob}(*) is deterministic, such as plain-RSA. Hence, Alice reveals the random session keys to the verifier during the verifying process. This encryption method also provides protection against the adaptive chosen ciphertext attack, although this protection is only heuristic and not achieved for at the instantiations of the encryption algorithm.

The two protocols set forth above reduce the demand on the fully trusted party, which needs only be involved in the case of disputes. This can also be improved by using threshold cryptosystems, such as those described in Desmedt et al., Advances in Cryptology—CRYPTO '87, pages 120-127 (1987) and Even et al., Comm. ACM 28(6):637-647 (1985), instead of traditional public-key cryptography. This would be accomplished by having n TTPs instead of a single TTP and encrypt messages such that only t≦n or mor TTPs can decrypt them. In a threshold cryptosystem, the secret key is shared among the participants using the t-out-of-n secret sharing scheme. Once the message is encrypted, each participant takes an input of the ciphertext and his share and returns as output the original plaintext. If at least t participants follow the decryption protocol, then the original message is recorded successfully. This invention can be modified to support multiple TTPs, in either protocol, by selecting the encryption function P_{TTP}(*) as a threshold cryptosystem.

The approach presented does not require the TTP to keep state (the TTP does not store any value). The approach does require a reliable channel between Bob and the TTP, however, the number of disputes will be drastically reduced because the protocols will promote the PA to act honestly more often than a totally untrusted sender. This should increase Bob's willingness to participate by providing his signature; Bob will only be signing receipts for requests originating from certified agents, rather than from unknown senders. Bob has a further incentive: the duration of his interchange with PA is likely short, preferably in terms of seconds. This is because PA is an online server always available, whereas Alice, the sender, may not reply promptly, putting Bob at risk.

An example of a suitable system implementation may be as follows. It is preferably to have an efficient platform, but it is also preferable to have a system that is highly usable and able to support several authentication methods (e.g., PGP-type or X.509 certificates). An important parameter to consider on the platform type is that it should be able to incorporate existing, freely available cryptographic libraries. Good results have been obtained when employing OpenSSL to provide SSL capabilities (http://openssl.org) and a modified Gnu GPG library (http://www.gnupg.org) to sign and encrypt messages.

The client application preferably provides a user interface through a SSL-enabled web server. The PA servers can be implemented on Linux machines running the Apache web server (http://www.apache.org) with the module mod_ssl enabled which allows the SSL secure connections (http:/www.mod_ssl.org). Daemons running these computers performed all the agents' transactions automatically. One might also use Java servlets for the daemons instead of CGI/bin since the web server can satisfy a client request through a single process allowing handling more transactions simultaneously and more robustly. The use interface ideally should be a standalone application, with capabilities of web browsing (including SSL connections). However, one can also borrow the web servers running the postal agents.

The TTP is the security critical server. The requests are logged into the trusted server, and the operator immediately prompts for assistance. The trusted server itself can be a machine dedicated to this service that is protected by a firewall and unavailable for remote login. A suitable machine may be an 800 MHz pentium III, 256 MB RAM Linux box.

The client graphical user interface (GUI) is preferably extremely simple. For example, Alice the sender, can be prompted on the display for an ID and password. A button can be provided which is labeled “Resources” which, if pressed, will pop up a window from where Alice can specify the files containing information such as certificates and keys, and also enter bookmarks to web directories from where user certificates/public-keys can be downloaded. Alice's own certificates are preferably displayed in a list window. Similarly, the certificates and Ids of the postal agents can be shown in a list window. Alice can specify the name of the recipient in a field labeled “Receiver Identification”, and, by pressing a “Fetch certificate” button, download the corresponding certificate which will be displayed in a list window. Most messages will consist only of attached files. However, a simple text composer can also be included for convenience and be activatable by a button. By pressing a “Send/Exit” button, Alice can send the encrypted request to the postal agent. The receiver, Bob, will receive a secure URL to point to. Then using an SSL-enabled browser, he provides the receipt and receives back the message promptly.

While the invention has been described in terms of its preferred embodiments, those skilled in the art will recognize that the invention can be practiced with modification within the spirit and scope of the appended claim.

What is claimed is:

1. A method for fair exchange of electronic information, comprising the steps of:
sending from a sender to a postal agent who is other than a trusted third party a sender's two-part message, the first part being signed by the sender and comprising a protocol header concatenated to a twice-encrypted message that is intelligible only to the trusted third party, and the second part being a once-encrypted message that is intelligible only to a recipient;
sending from the postal agent to a recipient the postal agent's two-part message, a first part being a first part of the sender's two-part message and a second part being the sender's twice-encrypted message concatenated with the postal agent's protocol header and signed by the postal agent; and
sending from the recipient to the postal agent a receipt, said receipt being the sender's twice-encrypted message concatenated with a recipient's protocol header and signed by the recipient

2. The method for fair exchange of electronic information recited in claim 1, further comprising the steps of:
sending from the postal agent to the sender said receipt; and
sending from the postal agent to the recipient the sender's once-encrypted message.

3. The method for fair exchange of electronic information recited in claim 1, further comprising the steps of:
sending from the recipient to the trusted third party the first part of the postal agent's two-part message and a receipt, said receipt being the sender's twice-encrypted message concatenated with a recipient's protocol header and signed by the recipient;
decrypting the sender's twice-encrypted message to obtain the sender's once-encrypted message that is intelligible only to the recipient;
sending from the trusted third party to the recipient the sender's once-encrypted message; and
sending from the trusted third party to the sender the receipt.

4. A method for fair exchange of electronic information, comprising the steps of:
sending from a sender to a recipient a sender's two-part message, a first part being signed by the sender and comprising a protocol header concatenated to a twice-encrypted message that is intelligible only to the trusted third party, and the second part being a postal-agent-encrypted message that is intelligible only to a postal agent, who is other than the trusted third party; and
sending from a recipient to the postal agent who is other than the trusted third party the first part of the sender's two-part message and a receipt, said receipt being the sender's twice-encrypted message concatenated with a recipient's protocol header concatenated with the postal-agent-encrypted message, and signed by the recipient.

5. The method for fair exchange of electronic information recited in claim 4, further comprising the steps of:
decrypting the postal-agent-encrypted message to obtain sender's once-encrypted message that is intelligible only to the recipient;
sending from the postal agent to the recipient the sender's once-encrypted message; and
sending from the postal agent to the sender the receipt.

6. The method for fair exchange of electronic information recited in claim 4, further comprising the steps of:
sending from the recipient to the trusted third party the first part of the sender's two-part message and a receipt, said receipt being the sender's twice-encrypted message concatenated with a recipient's protocol header and signed by the recipient,
decrypting the sender's twice-encrypted message to provide the sender's once-encrypted message to the trusted third party,
sending from the trusted third party to the recipient the sender's once-encrypted message; and
sending from the trusted third party to the sender the receipt.

7. A method for fair exchange of electronic information, comprising the steps of:
a sender obtaining a once-encrypted message by encrypting a message in such a way as to render it intelligible only to a recipient, the sender then concatenating this once-encrypted message with a sender's protocol header, the sender then obtaining a twice-encrypted message by further encrypting the concatenated, once-encrypted message in such a way that it is intelligible only to a trusted third party, the sender then concatenating the twice-encrypted message with a sender's protocol header, and the sender then signing the concatenated, twice-encrypted message;
the sender sending to a postal agent who is other than the trusted third party a sender's two-part message, a first part being the signed, concatenated, twice-encrypted message and a second part being the sender's once-encrypted message;
the postal agent receiving said sender's two-part message;
the postal agent sending a postal agent's two-part message to a recipient, a first part being a first part of the sender's two-part message and a second part being the sender's twice-encrypted message concatenated with a postal agent's protocol header and signed by the postal agent;
a recipient receiving said postal agent's two-part message;
the recipient then performing steps selected from one of the following groups:
(i) returning to the postal agent a receipt, said receipt being the sender's twice-encrypted message concatenated with a recipient's protocol header and signed by the recipient,
the postal agent then receiving said receipt, the postal agent then sending said receipt to the sender and sending the sender's once-encrypted message to the recipient, and
(ii) the recipient sending to a trusted third party the first part of the postal agent's two-part message and a receipt, said receipt being the sender's twice-encrypted message concatenated with a recipient's protocol header and signed by the recipient,
the trusted third party receiving said first part of postal agent's two-part message and said receipt and decrypting the sender's twice-encrypted message to obtain the sender's once-encrypted message, and then sending to the recipient the sender's once-encrypted message and sending to the sender the receipt.

8. The method of claim 7 wherein the step of the sender sending the sender's two-part message comprises sending the sender's two part message to a plurality of postal agents, and wherein each of said plurality of postal agents sending a postal agent's two-part message to the recipient.

9. The method of claim 7 wherein a plurality of once-encrypted messages are obtained in said obtaining step, each of said plurality of once-encrypted messages containing only a portion of a message to be sent between said sender and said recipient.

10. The method of claim 7 in which the sender's protocol header includes at least one of the following information identifying the sender, the recipient, the postal agent, and the trusted third party, a time stamp, a time limit, and information which describes encryption, authentication, and signature algorithm used in the sender's protocol header.

11. The method of claim 7 in which the postal agent's protocol header includes at least one of the following information identifying the sender, the recipient, the postal agent, and the trusted third party, a time stamp, a time limit, and information which describes encryption, authentication, and signature algorithm used in the postal agent's protocol header.

12. The method of claim 7 in which the recipient's protocol header includes at least one of the following information identifying the sender, the recipient, the postal agent, and the trusted third party, a time stamp, a time limit, and information which describes encryption, authentication, and signature algorithm used in the recipient's protocol header.

13. The method of claim 7 wherein said trusted third party comprises a plurality of servers, each of which receives and sends different portions of a message to be transferred between said sender and recipient if a dispute arises.

14. A method for fair exchange of electronic information, comprising the steps of:
a sender obtaining a once-encrypted message by encrypting a message in such a way as to render it intelligible only to a recipient, the sender then concatenating this once-encrypted message with a sender's protocol header, the sender then obtaining a twice-encrypted message by further encrypting the concatenated, once-encrypted message in such a way that it is intelligible only to a trusted third party, the sender then concatenating the twice-encrypted message with a sender's protocol header, the sender then signing the concatenated, twice-encrypted message,
the sender obtaining a postal-agent-encrypted message by further encrypting the sender's once-encrypted message in such a way as to render it intelligible only to a postal agent,
the sender sending to a recipient a sender's two-part message, a first part being the signed, concatenated, twice-encrypted message and a second part being the postal-agent-encrypted message,
a recipient then receiving said sender's two-part message, then performing steps selected from one of the following groups:
(i) the recipient then sending to a postal agent who is other than the trusted third party the first part of the sender's two-part message and a receipt, said receipt being the sender's twice-encrypted message concatenated with a recipient's protocol header, further concatenated with the postal-agent-encrypted message, and signed by the recipient,
the postal agent then receiving said first part of sender's two-part message and said receipt and decrypting the postal-agent-encrypted message to obtain sender's once-encrypted message, the postal agent then sending to the recipient the sender's once-encrypted message and sending to the sender the receipt, and
(ii) the recipient sending to the trusted third party the first part of the sender's two-part message and a receipt, said receipt being the sender's twice-encrypted message concatenated with a recipient's protocol header and signed by the recipient,
the trusted party then receiving said first part of sender's two-part message and said receipt and decrypting the sender's twice-encrypted message to obtain the sender's once-encrypted message, and
the trusted third party then sending to the recipient the sender's once-encrypted message and sending to the sender the receipt.

15. A method for the fair exchange of messages between a sender and a recipient, comprising the steps of:
electronically contracting a postal agent for a delivery of a message to a recipient, wherein contents of the message are hidden from the postal agent;
sending a message from the postal agent to the recipient and collecting by the postal agent of a receipt signed by the recipient, through execution of an optimistic protocol;
forwarding the receipt from the postal agent to the sender; and
resolving of disputes between said postal agent and said recipient by a trusted third party.

16. The method of claim 15 wherein said postal agent comprises a plurality of servers.

17. The method of claim 15 wherein said trusted third party comprises a plurality of servers.
